(19) United States
(12) Patent Application Publication
(10) Pub. No.: US 2012/0145305 A1
(43) Pub. Date: Jun. 14, 2012

(54) CARRIER TAPE FOR FOAM MATERIAL

(75) Inventors: Mitsuo Matsumoto, Ibraki-shi (JP); Takeshi Yamanaka, Ibraki-shi (JP); Mitsuru Naitou, Ibraki-shi (JP); Itsuhiro Hatanaka, Ibraki-shi (JP); Ikkou Hanaki, Ibraki-shi (JP)

(73) Assignee: NITTO DENKO CORPORATTION, Ibaraki-shi (JP)

(21) Appl. No.: 13/391,438

(22) PCT Filed: Jul. 30, 2010
(86) PCT No.: PCT/JP2010/062892

§ 371 Date: Feb. 21, 2012

(30) Foreign Application Priority Data
Aug. 25, 2009 (JP) 2009-194378
Jul. 21, 2010 (JP) 2010-163700

(51) Int. Cl. B32B 37/12; B32B 7/02; C09J 133/02; B32B 5/00; B32B 7/12; C09J 7/02

(52) U.S. Cl. 156/60; 428/343; 428/355 AC; 428/335; 428/337; 428/215

(57) ABSTRACT

Provided is a carrier tape for a foam material which exhibits satisfactory holding properties to a flexible foam material, exhibits satisfactory removability without causing fracture of the foam material, and has good peel properties upon picking up. The carrier tape for a foam material includes a substrate and, arranged on one side thereof, a pressure-sensitive adhesive layer. The carrier tape has a 180-degree peel strength of 0.15 N/20 mm or more at a tensile speed of 300 mm/min with respect to a foam (trade name “SCF100”, supplied by Nitto Denko Corporation). The carrier tape also has a 180-degree peel strength of 0.30 N/20 mm or less at a tensile speed of 10 m/min with respect to the foam (trade name “SCF100”, supplied by Nitto Denko Corporation).

### TECHNICAL FIELD

The present invention relates to a carrier tape for a foam material. Specifically, the present invention relates to a carrier tape for a foam material, which is used typically in transportation of the foam material, punching or another processing on the foam material, assembly of the foam material to a cabinet, and picking up of the foam material.

### BACKGROUND ART

Foam materials made from foams (foamed structures) have been widely used as infilling sealants in various industrial products including members such as those for building and civil engineering, electric appliances, household appliances, shipping, vehicles, and automobiles, typically for the purposes of dust proofing, thermal insulation, acoustic insulation, vibration insulation, cushioning (shock absorption), water sealing, and hermetic sealing. In addition, the foam materials are also widely used in the area of information appliances such as personal computers, cellular phones, or personal digital assistants (PDAs).

Foam materials have foamed structures, and some of them thereby have inferior strengths. Independently, some foam materials have a pressure-sensitive adhesive layer for the fixation to an adherend. Accordingly, carrier tapes are generally used on foam materials for easy handling and for satisfactory workability, typically upon transportation of the foam materials, punching on the foam materials, assembly of the foam materials to cabinets, and picking up of the foam materials.

As an example of its usage, a carrier tape for a foam material is used for a foam material (foam material having a structure of [(foam layer)/(pressure-sensitive adhesive layer)/(release liner)]) which structurally includes a foam; a pressure-sensitive adhesive layer arranged on one side of the foam; and a release liner arranged to protect the pressure-sensitive adhesive layer. Specifically, (1) the carrier tape for a foam material is affixed to a foam-layer side of the foam material (the side on which the pressure-sensitive adhesive layer and the release liner are not arranged) so as to hold the foam material on the carrier tape. (2) After the affixation of the carrier tape for a foam material, the foam material is punched to a predetermined shape by putting a punching blade from the other side of the foam material where the pressure-sensitive adhesive layer and the release liner are arranged to the foam material alone, and removing an unnecessary portion. Pieces of the foam material punched after being held on the carrier tape are arranged on the carrier tape at predetermined intervals; and this work, when being long, may be suitably wound as a roll. (3) Next, the work is transported to an assembling step, in which the release liner is removed from the foam material to expose the pressure-sensitive adhesive layer, and the exposed pressure-sensitive adhesive layer is affixed to a product member (e.g., cabinet). Thereafter the carrier tape for a foam material is removed from the foam material. Thus, the carrier tape for a foam material may be used as a mount upon punching of a foam material and may be used as a carrier member to an assembling step. In addition, processes or steps from punching to affixation can be automated by mechanizing the steps (1) to (3).

Such a carrier tape for a foam material requires holding properties to the foam material (properties of exhibiting a sufficient bond strength to a surface provided by the foam layer of the foam material) and requires removability (peelability) from the foam material upon removal (peeling) from the foam material (properties to be easily removable from the surface provided by the foam layer of the foam material without fracture of the foam material). In addition, the carrier tape for a foam material may be used for picking up of a specific foam material. The specific foam material has a multilayer structure of a pressure-sensitive adhesive layer and a release liner in addition to a foam layer and has, as its surfaces, a surface provided by the release liner in the multilayer structure of the pressure-sensitive adhesive layer and the release liner, and a surface provided by the foam layer. Examples of the specific foam material include a foam material having a structure of [(foam layer)/(pressure-sensitive adhesive layer)/(release liner)]. Upon the picking up of the specific foam material, the carrier tape for a foam material also requires peel properties. The peel properties are properties to exhibit a sufficient bond strength to the surface provided by the foam layer of the foam material and to undergo interfacial peeling only at the interface between the pressure-sensitive adhesive layer and the release liner.

A carrier tape for a foam material, if designed to have a higher bond strength to the foam material so as to improve the holding properties and the peel properties upon picking up, may suffer from problems such as fracture of the foam material (foam fracture) upon the removal of the carrier tape from the foam material. In contrast, a carrier tape for a foam material, if designed to have a lower bond strength to the foam material so as to improve the removability, may suffer from problems due to lowered holding properties, such as imperfect processing upon processing of the foam material, transportation trouble upon transportation of the foam material, and picking up failure of peeling at the interface between the carrier tape and the foam material upon picking up of the foam material.

As has been described above, the carrier tape for a foam material requires such properties as to exhibit a high bond strength and a low bond strength to the foam material as circumstances demand. Specifically, the carrier tape for a foam material requires trade-off properties.

As a carrier tape satisfying the trade-off properties, there is known a carrier tape having a pressure-sensitive adhesive layer made from a pressure-sensitive adhesive composition containing a paraffin oil (see Patent Literature (PTL) 1). This carrier tape, however, fails to satisfy the trade-off properties and may be hard to be used for flexible foam materials which have been recently widely used, although the carrier tape satisfies the trade-off properties and can be effectively used for hard or rigid foam materials.

### CITATION LIST

### Patent Literature

PTL 1: Japanese Unexamined Patent Application Publication (JP-A) No. 2006-143299

### SUMMARY OF INVENTION

### Technical Problem

An object of the present invention is to provide a carrier tape for a foam material, which exhibits satisfactory holding properties to a flexible foam material, exhibits satisfactory removability without causing fracture of the foam material, and also has satisfactory peel properties upon picking up.

### Solution to Problem

After intensive investigations to achieve the object, the present inventors have found that, when a carrier tape for a foam material is designed to have a 180-degree peel strength of 0.15 N/20 mm or more at a tensile speed of 300 mm/min with respect to a foam (trade name “SCF100”, supplied by Nitto Denko Corporation) and to have a 180-degree peel strength of 0.30 N/20 mm or less at a tensile speed of 10 m/min with respect to the foam (trade name “SCF100”, supplied by Nitta Denko Corporation), the resulting carrier tape for a foam material exhibits a sufficient bond strength to a flexible foam material to obtain satisfactory holding properties and satisfactory peel properties upon picking up and exhibits satisfactory removability from the flexible foam material to allow the foam material to be easily separated from the carrier tape without fracture of the foam material. The present invention has been made based on these findings.

Specifically, the present invention provides, in an aspect, a carrier tape for a foam material. The carrier tape includes a substrate; and a pressure-sensitive adhesive layer present on or above one side of the substrate. The carrier tape has a 180-degree peel strength of 0.15 newton per 20 millimeters (N/20 mm) or more at a tensile speed of 300 millimeters per minute (mm/min) with respect to a foam (trade name “SCF100”, supplied by Nitto Denko Corporation), and the carrier tape has a 180-degree peel strength of 0.30 N/20 mm or less at a tensile speed of 10 meters per minute (m/min) with respect to the foam (trade name “SCF100”, supplied by Nitto Denko Corporation).

In the carrier tape for a foam material according to the present invention, the pressure-sensitive adhesive layer may be an acrylic pressure-sensitive adhesive layer.

In the carrier tape for a foam material according to the present invention, the pressure-sensitive adhesive layer may contain a crosslinking agent.

In the carrier tape for a foam material according to the present invention, the acrylic pressure-sensitive adhesive layer may principally include an acrylic polymer including, as a principal structural component, an alkyl (meth)acrylate whose alkyl moiety having 1 to 14 carbon atoms.

In the carrier tape for a foam material according to the present invention, the acrylic copolymer may be a water-dispersive acrylic copolymer.

In the carrier tape for a foam material according to the present invention, the pressure-sensitive adhesive layer preferably has a thickness of from 2 to 40 μm.

In the carrier tape for a foam material according to the present invention, the substrate preferably has a thickness of from 1 to 1000 μm.

The present invention provides, in another aspect, a method for transporting a foam material. The method uses the carrier tape for a foam material.

In yet another aspect, the present invention provides a method for processing a foam material. The method uses the carrier tape for a foam material.

In addition and advantageously, the present invention provides a method for assembling a foam material. The method uses the carrier tape for a foam material.

### ADVANTAGEOUS EFFECTS OF INVENTION

The carrier tape for a foam material according to the present invention, as having a 180-degree peel strength of 0.15 N/20 mm or more at a tensile speed of 300 mm/min with respect to a foam (trade name “SCF100”, supplied by Nitto Denko Corporation), exhibits satisfactory holding properties and exhibits satisfactory peel properties upon picking up each with respect to a flexible foam material. In addition, the carrier tape for a foam material according to the present invention, as having a 180-degree peel strength of 0.30 N/20 mm or less at a tensile speed of 10 m/min with respect to the foam (trade name “SCF100”, supplied by Nitto Denko Corporation), exhibits satisfactory removability from a flexible foam material without causing fracture of the foam material.

### BRIEF DESCRIPTION OF DRAWINGS

FIG. 1 is a schematic cross-sectional view of an evaluation sample for use in the evaluation of picking-up properties.

### DESCRIPTION OF EMBODIMENTS

A carrier tape for a foam material according to the present invention is a pressure-sensitive adhesive tape having a substrate and, arranged on one side thereof, a pressure-sensitive adhesive layer. The carrier tape for a foam material according to the present invention holds the foam material by the action of the pressure-sensitive adhesive layer arranged on one side of the substrate. As used herein the term “pressure-sensitive adhesive tape (self-adhesive tape)” also includes one in the form of a sheet, i.e., a “pressure-sensitive adhesive sheet (self-adhesive sheet).”

The carrier tape for a foam material according to the present invention has such properties that the carrier tape has a 180-degree peel strength of 0.15 N/20 mm or more at a tensile speed of 300 mm/min with respect to the foam (trade name “SCF100”, supplied by Nitto Denko Corporation) and that the pressure-sensitive adhesive layer has a 180-degree peel strength of 0.30 N/20 mm or less at a tensile speed of 10 m/min with respect to the foam (trade name “SCF100”, supplied by Nitto Denko Corporation). The properties are obtained on a surface provided by the pressure-sensitive adhesive layer arranged on one side of the substrate (surface of the pressure-sensitive adhesive layer, adhesive face). As used herein the “foam (trade name “SCF100”, supplied by Nitto Denko Corporation)” is also referred to as “foam (SCF100).”

Thus, the carrier tape for a foam material according to the present invention exhibits properties as mentioned below (e.g., holding properties, removability, and peel properties upon picking up of a specific foam material) regardless of the degrees or magnitudes of the strength and rigidity of the foam material. In particular, the carrier tape for a foam material according to the present invention is effective for a flexible foam material.

The carrier tape for a foam material according to the present invention exhibits a sufficient bond strength to a foam material to hold the foam material and exhibits removability from the foam material and can thereby be easily separated from the foam material without causing fracture of the foam material, after holding the foam material.

In addition, the carrier tape for a foam material according to the present invention may be used for picking up of a certain foam material. This foam material has a multilayer structure of a pressure-sensitive adhesive layer and a release liner in addition to a foam layer and has, as its surfaces, a surface provided by the release liner in the multilayer structure of the pressure-sensitive adhesive layer and the release liner, and a surface provided by the foam layer. Examples of the foam material of this type include a foam material having a structure of [(foam layer)/(pressure-sensitive adhesive layer)/(release liner)]. Upon picking up of this foam material, the carrier tape for a foam material according to the present invention exhibits a sufficient bond strength to a surface which is to be picked up and which is provided by the foam layer of the foam material. Accordingly, upon picking up, interfacial peeling occurs not at the interface between the carrier tape and the foam material but only at the interface between the pressure-sensitive adhesive layer and the release liner both in the foam material to be picked up. As used herein such a “foam material having a multilayer structure of a pressure-sensitive adhesive layer and a release liner in addition to a foam layer and having, as its surfaces, a surface provided by the release liner in the multilayer structure of the pressure-sensitive adhesive layer and the release liner, and a surface provided by the foam layer” is also referred to as a “specific foam material.”

Specifically, the carrier tape for a foam material according to the present invention has such properties as to exhibit, upon picking up of the specific foam material, a sufficient bond strength to the surface provided by the foam layer of the foam material to thereby allow interfacial peeling to occur only at the interface between the pressure-sensitive adhesive layer and the release liner both in the specific foam material (the properties are also simply referred to as “peel properties”).

The carrier tape for a foam material according to the present invention has a 180-degree peel strength at a tensile speed of 300 mm/min with respect to the foam (SCF100) [180-degree peel strength to the foam (SCF100) under the low-speed peel condition] of 0.15 N/20 mm or more (e.g., from 0.15 to 1.0 N/20 mm), preferably 0.18 N/20 mm or more (e.g., from 0.18 to 0.5 N/20 mm), and more preferably 0.2 N/20 mm or more (e.g., from 0.2 to 0.4 N/20 mm).

When the carrier tape for a foam material according to the present invention is used, the behavior of holding the foam material relates to a peel phenomenon at low speed typically in transportation of the foam material, processing (particularly punching) on the foam material, assembly of the foam material to a cabinet, and picking up of the foam material. The carrier tape, if having a 180-degree peel strength under the low-speed peel condition of less than 0.15 N/20 mm with respect to the foam (SCF100), may not exhibit sufficient bonding reliability to a foam material. Typically, upon transportation of the foam material, the carrier tape may fail to hold the foam material and may thereby cause dropping off of the foam material (transportation trouble); or the carrier tape may fail to reliably hold the foam material upon processing (particularly punching) on the foam material and may thereby cause imperfect processing; or the carrier tape may fail to hold the foam material upon assembly of the foam material to a cabinet or upon picking up of the foam material and may thereby cause imperfect assembly or imperfect picking up. In addition in this case, when the carrier tape for a foam material according to the present invention is used for picking up of the specific foam material, the carrier tape may fail to exhibit a sufficient bond strength to the surface provided by the foam layer of the foam material and may thereby suffer from interfacial peeling at the interface between the carrier tape and the specific foam material or may fail to allow interfacial peeling to occur at the interface between pressure-sensitive adhesive layer and the release liner both in the specific foam material.

The carrier tape for a foam material according to the present invention has a 180-degree peel strength at a tensile speed of 10 m/min with respect to the foam (SCF100) [180-degree peel strength to the foam (SCF100) under the high-speed peel condition] of 0.30 N/20 mm or less (e.g., from 0.01 to 0.30 N/20 mm), preferably 0.25 N/20 mm or less (e.g., from 0.05 to 0.25 N/20 mm), and more preferably 0.2 N/20 mm or less (e.g., from 0.1 to 0.2 N/20 mm).

A behavior of the carrier tape upon removal from the foam material (behavior upon peeling off of the carrier tape) relates to a peel phenomenon at high speed. Upon peeling off (removal) of the carrier tape from the foam material, the carrier tape should be peeled off as interfacial peeling at the interface between the carrier tape and the foam material and, in addition, should suppress troubles or problems such as interfacial peeling at a position other than the interface between the carrier tape and the foam material (e.g., dropping off of the foam material from a cabinet upon removal of the carrier tape from the foam material after the completion of the assembly of the foam material to the cabinet), foam fracture, and adhesive deposit on the foam material. The pressure-sensitive adhesive layer, if having a 180-degree peel strength to the foam (SCF100) under the high-speed peel condition of more than 0.30 N/20 mm, may cause troubles or problems such as interfacial peeling at a position other than the interface between the carrier tape and the foam material, foam fracture, and adhesive deposit on the foam material.

In the present invention, the 180-degree peel strengths with respect to the foam (SCF100) are measured by a method mentioned later.

The foam (trade name “SCF100”, supplied by Nitto Denko Corporation) is a polypropylene (PP) foam, has a fine cell structure, and is flexible. The foam has an apparent density of 0.04 g/cm³, a 50% compression load of 1.2 N/cm², a breaking strength of 1.0 MPa, and a breaking elongation(breaking extension) of 210%.

### (Substrate)

The substrate (base material) constitutes part of the carrier tape for a foam material according to the present invention. The substrate plays a role as a transportation carrier particularly upon transportation of the foam material and plays a role as a mount upon processing, such as punching, on the foam material.

Examples of such substrates include, but are not limited to, suitable thin articles including paper-based substrates such as papers; fibrous substrates such as cloths, nonwoven fabrics, and nets (materials of which may be suitably selected typically from among Manila hemp, rayons, polyesters, and pulp fibers without limitation); metallic substrates such as metallic foils and metal sheets; plastic substrates such as plastic films or sheets; rubber substrates such as rubber sheets; foams such as foam sheets (expanded sheets); and laminate substrates of them (e.g., a laminate substrate of a plastic substrate and another substrate, and a laminate substrate of plastic films (or sheets) with each other.

Exemplary materials for such plastic films and sheets include olefinic resins each including an α-olefin as a monomer component, such as polyethylenes (PEs), polypropylenes (PPs), ethylene-propylene copolymers, and ethylene-vinyl acrylate copolymers (EVAs); polyester resins such as poly(ethylene terephthalate)s (PETS), polyethylene naphthalate)s (PENS), and polybutylene terephthalate)s (PETS); polyvinyl chloride)s (PVC); vinyl acrylate resins; poly(phenylene sulfide)s (PPSs); amide resins such as polyamides (nylons) and wholly aromatic polyamides (aramids); polyimide resins; and poly(ether ether ketone)s (PEEKS). Each of such materials may be used alone or in combination.

Among them, plastic substrates such as plastic films and sheets are preferred as the substrate, of which substrates including polyester resins as materials (polyester substrates) are more preferred. This is because the carrier tape preferably has rigidity (hardness) to some extent when used as a carrier upon transportation of the foam material or as a mount upon processing, such as punching, on the foam material.

When a plastic substrate is used as the substrate, elongation percentage and other deformation properties of the substrate may be controlled typically by drawing treatment. When the pressure-sensitive adhesive layer is formed through curing with an active energy ray, the substrate to be used is preferably one that does not inhibit the transmission of the active energy ray.

For increasing adhesion to the pressure-sensitive adhesive layer, the surface of the substrate may be subjected to a customary surface treatment including corona treatment, chromate treatment, exposure to ozone, exposure to flame, exposure to a high-voltage electric shock, treatment with ionizing radiation, or another oxidation treatment by a chemical or physical process; or may for example be subjected to a coating treatment typically with a primer or a release agent.

The thickness of the substrate may be suitably selected according typically to the strength, flexibility, and intended use and is, for example, generally 1000 μm or less (e.g., from 1 to 1000 μm), preferably from 1 to 500 μm, more preferably from 3 to 300 μm, and most preferably from 30 to 200 μm. The substrate may have either a single-layer structure or a multilayer structure.

### (Pressure-Sensitive Adhesive Layer)

The pressure-sensitive adhesive layer is not limited, as long as having such properties as to have a 180-degree peel strength of 0.15 N/20 mm or more at a tensile speed of 300 mm/min with respect to the foam (trade name “SCF100”, supplied by Nitto Denko Corporation) and to have a 180-degree peel strength of 0.30 N/20 mm or less at a tensile speed of 10 m/min with respect to the foam (trade name “SCF100”, supplied by Nitto Denko Corporation). The pressure-sensitive adhesive layer may be formed from a pressure-sensitive adhesive in any form and may be formed typically from a water-dispersive pressure-sensitive adhesive (emulsion pressure-sensitive adhesive), a solvent-borne pressure-sensitive adhesive, or a thermofusible pressure-sensitive adhesive (hot-melt pressure-sensitive adhesive).

Though not limited, the pressure-sensitive adhesive for use herein may be a pressure-sensitive adhesive which includes, as a base polymer (base resin), a polymer obtained by polymerization (or copolymerization) of a monomer component (monomer principal component) serving as a principal monomer component for the formation of the base polymer and, where necessary, a monomer copolymerizable with the principal monomer component. A technique for the polymerization is not limited and can be a customary technique known to those skilled in the art, such as ultraviolet-initiated polymerization (UV polymerization), solution polymerization, or emulsion polymerization.

Examples of the pressure-sensitive adhesive serving as a principal component for the formation of the pressure-sensitive adhesive layer include, but are not limited to, acrylic pressure-sensitive adhesives, rubber pressure-sensitive adhesives, vinyl alkyl ether pressure-sensitive adhesives, silicone pressure-sensitive adhesives, polyester pressure-sensitive adhesives, polyamide pressure-sensitive adhesives, urethane pressure-sensitive adhesives, fluorine-containing pressure-sensitive adhesives, epoxy pressure-sensitive adhesives, and other pressure-sensitive adhesives. Each of such pressure-sensitive adhesives may be used alone or in combination.

Acrylic pressure-sensitive adhesives are preferably used as the pressure-sensitive adhesive from the points typically of easy control of modulus of elasticity, weatherability, and durability, of which preferred is an acrylic pressure-sensitive adhesive which includes, as a base polymer, a copolymer (acrylic copolymer) containing, as a principal constitutional component, an acrylic monomer represented by following Formula (1):

CH₂═CR₁COOR₂ (1)

wherein R₁ is hydrogen atom or methyl group; and R₂ is an alkyl group.

The acrylic monomer represented by Formula (1) is an alkyl (meth)acrylate having an alkyl group, in which the alkyl group R₂ is a linear or branched-chain alkyl group (e.g., a linear or branched-chain alkyl group having 1 to 14 carbon atoms).

Specifically, the pressure-sensitive adhesive layer of the carrier tape for a foam material according to the present invention is preferably an acrylic pressure-sensitive adhesive layer, and more preferably an acrylic pressure-sensitive adhesive layer including as a principal component (base polymer) a copolymer (acrylic copolymer) formed from an acrylic monomer represented by Formula (1) as a principal constitutional component.

The acrylic pressure-sensitive adhesive layer may include the acrylic copolymer as a base polymer in an amount of 70 percent by weight or more, and preferably 80 percent by weight or more, based on the total amount of the acrylic pressure-sensitive adhesive layer.

Such an acrylic copolymer is preferably formed by polymerization of a monomer mixture containing an acrylic monomer represented by Formula (1) as a principal component (hereinafter also referred to as “acrylic monomer mixture”) and, in the present invention, is particularly preferably formed by polymerization of an acrylic monomer mixture containing an acrylic monomer represented by Formula (1) in a content of from 50 to 99.9 percent by weight and a carboxyl-containing monomer in a content of from 0.1 to 5 percent by weight.

Exemplary acrylic monomers represented by Formula (1) include alkyl (meth)acrylates whose alkyl moiety having 1 to 14 carbon atoms, such as methyl (meth)acrylate, ethyl (meth)acrylate, propyl (meth)acrylate, isopropyl (meth)acrylate, butyl (meth)acrylate, isobutyl (meth)acrylate, s-butyl (meth)acrylate, t-butyl (meth)acrylate, pentyl (meth)acrylate, isopentyl (meth)acrylate, hexyl (meth)acrylate, heptyl (meth)acrylate, octyl (meth)acrylate, 2-ethylhexyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, dodecyl (meth)acrylate, tridecyl (meth)acrylate, and tetradecyl (meth)acrylate. Each of different acrylic monomers may be used alone or in combination.

Though not critical as long as being used as a principal monomer component, the acrylic monomer is preferably contained in the acrylic monomer mixture in a content of from 50 to 99.9 percent by weight (preferably from 60 to 99 percent by weight, and more preferably from 67 to 89.5 percent by weight) based on the total amount of monomer components constituting the acrylic monomer mixture. The acrylic monomer mixture, if having an acrylic monomer content of less than 50 percent by weight, may cause the acrylic pressure-sensitive adhesive layer to have insufficient initial adhesiveness to the foam material.

The acrylic monomer mixture for use in the present invention preferably further contains a carboxyl-containing monomer copolymerizable with the acrylic monomer, in addition to the acrylic monomer serving as a principal monomer component. The carboxyl-containing monomer helps the acrylic pressure-sensitive adhesive layer to have higher adhesion to the substrate and helps the acrylic pressure-sensitive adhesive layer to have higher initial adhesiveness to the foam material.

The carboxyl-containing monomer is a monomer having both a carboxyl group and a carbon-carbon unsaturated bond in one molecule. Exemplary carboxyl-containing monomers include (meth)acrylic acid, itaconic acid, maleic acid, fumaric acid, crotonic acid, and isocrotonic acid. Each of different carboxyl-containing monomers may be used alone or in combination.

The acrylic monomer mixture desirably contains the carboxyl-containing monomer in a content of from 0.1 to 5.0 percent by weight (preferably from 0.5 to 3.0 percent by weight) based on the total amount of monomer components constituting the acrylic monomer mixture. The monomer mixture, if having a content of the carboxy-containing monomer of less than 0.1 percent by weight, may tend to cause problems such as insufficient adhesion of the acrylic pressure-sensitive adhesive layer to the substrate. In contrast, the monomer mixture, if having a content of the carboxy-containing monomer of more than 5.0 percent by weight, may cause the acrylic pressure-sensitive adhesive layer to have an increasing bond strength to the foam material with time.

The acrylic monomer mixture may further include a copolymerizable monomer that is copolymerizable, in addition to the carboxyl monomer. Such a copolymerizable monomer, when used, helps the acrylic pressure-sensitive adhesive to have a higher cohesive strength and to thereby have a higher bond strength to the foam material. Each of different copolymerizable monomers may be used alone or in combination.

Exemplary copolymerizable monomers include, in addition to multifunctional monomers mentioned later, cyclohexyl (meth)acrylate, benzyl (meth)acrylate, isobornyl (meth)acrylate, t-butylcyclohexyl (meth)acrylate, vinyl acrylate, styrene, glycidyl (meth)acrylate, 2-hydroxyethyl (meth)acrylate, 2-hydroxypropyl (meth)acrylate, methyl (meth)acrylate, N-(meth)acryloylmorpholine, N-(meth)acryloylpyrrolidone, N,N-dimethyl (meth)acrylamide, and N-vinyl-2-pyrrolidone. Such copolymerizable monomer(s) is desirably used in the acrylic monomer mixture in a content of preferably 49.9 percent by weight or less, and more preferably 30 percent by weight or less, based on the total amount of monomer components constituting the acrylic monomer mixture. This is because the copolymerizable monomer(s), if present in a content of more than 49.9 percent by weight, may often cause the pressure-sensitive adhesive layer to have insufficient initial adhesiveness.

Exemplary multifunctional monomers serving as the copolymerizable monomer include methylenebisacrylamide, 1,6-hexanediol di(meth)acrylate, and trimethylolpropane tri(meth)acrylate. The amount of the multifunctional monomer(s) is 2 percent by weight or less (e.g., from 0.01 to 2 percent by weight), and preferably from 0.02 to 1 percent by weight, based on the total amount of monomer components constituting the acrylic monomer mixture. Multifunctional monomer(s), if used in an amount of more than 2 percent by weight, may cause the acrylic pressure-sensitive adhesive layer to have an excessively high cohesive strength to thereby have a low tackiness. In contrast, if the amount of multifunctional monomer(s) is excessively small (e.g., if less than 0.01 percent by weight), this may cause, for example, the acrylic pressure-sensitive adhesive layer to have an insufficient cohesive strength.

As is described above; the acrylic copolymer is formed using a customary technique known to those skilled in the art, such as UV polymerization, solution polymerization, or emulsion polymerization. The acrylic copolymer for use in the present invention is preferably a copolymer (water-dispersive acrylic copolymer) which is formed by emulsion polymerization of an acrylic monomer mixture and is particularly preferably a water-dispersive acrylic copolymer which is formed by emulsion polymerization of an acrylic monomer mixture containing the acrylic monomer in a content of 50 to 99.9 percent by weight and the carboxyl-containing monomer in a content of 0.1 to 5 percent by weight. Emulsion polymerization has such a feature as to give a base polymer having a high molecular weight, resulting in a highly elastic polymer. This can prevent the pressure-sensitive adhesive layer from having excessive adhesion to the foam material and can prevent fracture of the surface layer. Specifically, the pressure-sensitive adhesive layer of the carrier tape for a foam material according to the present invention is preferably a water-dispersive acrylic pressure-sensitive adhesive layer including the water-dispersive acrylic copolymer as a base polymer.

The acrylic monomer mixture may further include various additives (particularly polymerization initiators and other additives necessary for polymerization). Typically, an acrylic monomer mixture for the formation of a water-dispersive acrylic copolymer by emulsion polymerization generally includes a polymerization initiator and/or a surfactant for emulsion polymerization, in which the water-dispersive acrylic copolymer will serve as a base polymer of a water-dispersive acrylic pressure-sensitive adhesive layer.

A water-dispersive acrylic copolymer may be stably obtained, for example, by performing emulsion polymerization of the acrylic monomer mixture according to a common procedure, and, after the emulsion polymerization, performing a neutralization treatment with a neutralizer such as ammonia to adjust the pH to a predetermined pH.

Exemplary polymerization initiators to be contained in the acrylic monomer mixture for the formation of the water-dispersive acrylic copolymer by emulsion polymerization include potassium peroxodisulfate, ammonium persulfate, and 2,2-azobis(2-amidinopropane)dihydrochloride. Though not critical, such polymerization initiator(s) may be used, for example, in an amount of from 0.05 to 2.0 parts by weight per 100 parts by weight of monomer components constituting the acrylic monomer mixture. Each of different polymerization initiators may be used alone or in combination.

Examples of the surfactants for emulsion polymerization include nonionic surfactants and anionic surfactants. Each of different surfactants for emulsion polymerization may be used alone or in combination.

Exemplary nonionic surfactants include polyoxyethylene alkyl ethers, polyoxyethylene alkyl phenyl ethers, oxyethylene-oxypropylene block polymers, sorbitan fatty acid esters, and polyoxyethylene fatty acids. Though not critical, nonionic surfactant(s) is generally used in an amount of from 0.2 to 4 parts by weight per 100 parts by weight of monomer components constituting the acrylic monomer mixture.

Exemplary anionic surfactants include alkyl sulfuric esters, alkylbenzenesulfonic acids, alkyl sulfosuccinates, alkyl diphenyl ether disulfonates, polyoxyethylene alkyl sulfates, and polyoxyethylene alkyl phosphates. Though not critical, anionic surfactant(s) is generally used in an amount of 0.1 to 2 parts by weight per 100 parts by weight of monomer components constituting the acrylic monomer mixture.

The pressure-sensitive adhesive layer (particularly water-dispersive acrylic pressure-sensitive adhesive layer) of the carrier tape for a foam material according to the present invention may include one or more additives according to necessity.

The pressure-sensitive adhesive layer (particularly water-dispersive acrylic pressure-sensitive adhesive layer) of the carrier tape for a foam material according to the present invention preferably contains a phosphate (phosphate ester) surfactant including a phosphate represented by Formula (2a) or (2b), or a salt thereof, as an additive. This is because the use of the phosphate surfactant helps the carrier tape to be removed more easily without fracture of the surface layer of the foam material. Each of such phosphate surfactants may be used alone or in combination:

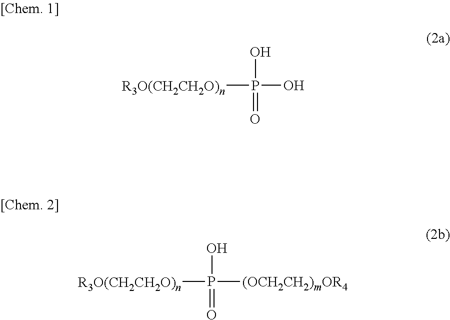

wherein “n” and “m” represent numbers of moles of added ethylene oxide (degrees of polymerization of ethylene oxide); and R₃ and R₄ are alkylaryl groups.

Exemplary salts of phosphates include sodium salts, potassium salts, barium salts, and triethanolamine salts of the phosphates represented by Formula (2a) or Formula (2b).

In Formula (2a) and Formula (2b), the numbers of moles of added ethylene oxide (“n” and “m” in the formulae) are both from 1 to 30, and preferably from 3 to 20 for satisfactory removability and for preventing fracture of the surface of the foam material.

Specific examples of such phosphate surfactants include polyoxyethylene nonylphenyl ether monophosphates, polyoxyethylene nonylphenyl ether diphosphates, polyoxyethylene octylphenyl ether monophosphates, polyoxyethylene octylphenyl ether diphosphates, and salts of them.

Though not critical, the content of phosphate surfactant(s) in the pressure-sensitive adhesive layer (particularly water-dispersive acrylic pressure-sensitive adhesive layer) is preferably from 0.1 to 3.0 parts by weight, and more preferably from 0.3 to 2.0 parts by weight, per 100 parts by weight of the base polymer of the pressure-sensitive adhesive layer (particularly a water-dispersive acrylic copolymer when the pressure-sensitive adhesive layer is a water-dispersive acrylic pressure-sensitive adhesive layer). The pressure-sensitive adhesive layer, if having a content of phosphate surfactant(s) of less than 0.1 part by weight, may have lower removability. In contrast, the pressure-sensitive adhesive layer, if having a content of phosphate surfactant(s) of more than 3.0 parts by weight, may suffer from problems such as insufficient water-proof and contamination (stain) to the adherend surface (adhesive deposit).

In addition, the pressure-sensitive adhesive layer (particularly water-dispersive acrylic pressure-sensitive adhesive layer) of the carrier tape for a foam material according to the present invention preferably contains a crosslinking agent from the point of obtaining satisfactory removability from the adherend. Each of different crosslinking agents may be used alone or in combination.

In particular, oxazoline-containing water-soluble crosslinking agents are preferred as the crosslinking agents. This is because oxazoline-containing water-soluble crosslinking agents have long pot lives, do not cause problems such as insufficient crosslinking, and allows the carrier tape to have further satisfactory removability from the adherend surface.

Any of oxazoline-containing water-soluble crosslinking agents may be used without limitation, as long as being one having an oxazoline group in the molecule. The oxazoline group may be any of 2-oxazoline group, 3-oxazoline group, and 4-oxazoline group. In general, water-soluble crosslinking agents each containing an 2-oxazoline group are preferably used.

Typical examples of oxazoline-containing water-soluble crosslinking agents include the oxazoline compounds disclosed in Japanese Unexamined Patent Application Publication (JP-A) No. H02-150482, of which preferred are copolymers of an addition-polymerizable 2-oxazoline having an unsaturated carbon-carbon bond on the carbon at the 2-position (e.g., 2-isopropenyl-2-oxazoline) with another unsaturated monomer. Exemplary commercial products of such water-soluble crosslinking agents include a product under the trade name “EPOCROS WS-500” (supplied by Nippon Shokubai Co., Ltd.).

Exemplary crosslinking agents other than the oxazoline-containing water-soluble crosslinking agents include polyisocyanate crosslinking agents, silicone crosslinking agents, epoxy crosslinking agents, and alkyl-etherified melamine crosslinking agents.

The content of crosslinking agent(s) in the pressure-sensitive adhesive layer is not critical, as long as the pressure-sensitive adhesive layer obtains desired removability. For example, when the pressure-sensitive adhesive layer is a water-dispersive acrylic pressure-sensitive adhesive layer and uses an oxazoline-containing water-soluble crosslinking agent as a crosslinking agent, the content of the oxazoline-containing water-soluble crosslinking agent in the water-dispersive acrylic pressure-sensitive adhesive layer is preferably such that the amount of oxazoline groups is from 0.1 to 5.0 equivalents per 1 equivalent of carboxyl groups contained in the water-dispersive acrylic copolymer serving as the base polymer, more preferably such that the amount is from 0.15 to 3.0 equivalents, furthermore preferably such that the amount is from 0.2 to 1.0 equivalent, and most preferably such that the amount is from 0.20 to 0.40 equivalent. If the amount is less than 0.1 equivalent, the pressure-sensitive adhesive layer may have inferior cohesiveness and show poor removability from the adherend. In contrast, if the amount is more than 5.0 equivalents, the pressure-sensitive adhesive layer may contain a large amount of unreacted water-soluble crosslinking agent not contributed to the water-dispersive copolymer, and this may cause a problem of contamination (stain) of the adherend.

The pressure-sensitive adhesive layer of the carrier tape for a foam material according to the present invention may further contain suitable additives according to the intended use, in addition to the phosphate surfactants and the oxazoline-containing water-soluble crosslinking agents. Typically, according to the type of the pressure-sensitive adhesive, the pressure-sensitive adhesive layer may include any of suitable additives such as tackifiers (e.g., those including rosin derivative resins, polyterpene resins, petroleum resins, or oil-soluble phenol resins and being solid, semisolid, or liquid at room temperature), plasticizers, fillers, age inhibitors, antioxidants, and colorants (e.g., carbon black and other pigments, and dyestuffs).

In particular, the pressure-sensitive adhesive layer of the carrier tape for a foam material according to the present invention is preferably a water-dispersive acrylic pressure-sensitive adhesive layer including a water-dispersive acrylic copolymer as a base polymer. The water-dispersive acrylic copolymer herein is formed by emulsion polymerization of an acrylic monomer mixture which contains acrylic monomers represented by Formula (1) in a content of from 50 to 99.9 percent by weight and carboxyl-containing monomer(s) in a content of from 0.1 to 5 percent by weight and which has a weight ratio [(alkyl acrylate)/(alkyl methacrylate)] of alkyl acrylate(s) to alkyl methacrylate(s) in the acrylic monomers of from 40/60 to 70/30. This is preferred because, among the alkyl (meth)acrylates, alkyl acrylates are liable to exhibit effects of imparting flexibility to the polymer constituting the pressure-sensitive adhesive layer and thereby helping the pressure-sensitive adhesive layer to develop adhesion and tackiness, whereas alkyl methacrylates are liable to exhibits effects of imparting hardness (rigidity) to the polymer constituting the pressure-sensitive adhesive layer and thereby controlling the removability of the pressure-sensitive adhesive layer.

The pressure-sensitive adhesive layer arranged on one side of the substrate in the carrier tape for a foam material according to the present invention is preferably a water-dispersive acrylic pressure-sensitive adhesive layer which includes a water-dispersive acrylic copolymer in an amount of from 92 to 99 percent by weight based on the total amount of the acrylic pressure-sensitive adhesive layer; a phosphate surfactant in an amount of from 0.1 to 3.0 parts by weight per 100 parts by weight of the water-dispersive acrylic copolymer; and an oxazoline-containing water-soluble crosslinking agent in such an amount that the amount of oxazoline groups is from 0.1 to 5.0 equivalents per 1 equivalent of carboxyl groups contained in the water-dispersive acrylic copolymer. The water-dispersive acrylic copolymer herein is formed by emulsion polymerization of an acrylic monomer mixture which contains an acrylic monomer represented by Formula (1) in a content of 50 to 99.9 percent by weight and carboxyl-containing monomer(s) in a content of 0.1 to 5 percent by weight and which has a weight ratio [(alkyl acrylate)/(alkyl methacrylate)] of alkyl acrylate(s) to alkyl methacrylate(s) in the acrylic monomers of from 40/60 to 70/30.

Exemplary processes for forming the pressure-sensitive adhesive layer include, but are not limited to, a process of forming the pressure-sensitive adhesive layer by applying a composition (pressure-sensitive adhesive composition) for the formation of the pressure-sensitive adhesive layer to a predetermined surface. Where necessary, drying and/or light irradiation, for example, may be performed in the formation process.

The pressure-sensitive adhesive composition may be prepared, for example, by mixing components such as a base polymer and additives, which are added according to the intended use, using a known technique. Specifically, a water-dispersive acrylic pressure-sensitive adhesive composition serving as a composition for the formation of the water-dispersive acrylic pressure-sensitive adhesive layer may be prepared by adding, according to necessity, various additives to a composition containing a water-dispersive acrylic copolymer obtained by emulsion polymerization of the acrylic monomer mixture. As used herein the term “pressure-sensitive adhesive composition” also means and includes a “composition for the formation of a pressure-sensitive adhesive.”

Though the thickness thereof is not critical, the pressure-sensitive adhesive layer, if having an excessively small thickness, may have poor adhesion to the foam material having an irregular surface and may not give a suitable adhesive strength. The pressure-sensitive adhesive layer, if having an excessively large thickness, may often cause the pressure-sensitive adhesive to cut into the foam material surface to thereby cause adhesive deposit and surface fracture of the foam material. To avoid these, the pressure-sensitive adhesive layer has a thickness of preferably from 2 to 40 μm, more preferably from 4 to 20 μm, and furthermore preferably from 5 to 15 μm. The pressure-sensitive adhesive layer may have either a single-layer structure or multilayer structure.

### (Release Liner)

The surface (adhesive face) of the pressure-sensitive adhesive layer of the carrier tape for a foam material according to the present invention may be protected by a release liner (separator) before use. The release liner is used as a protector of the pressure-sensitive adhesive layer and will be removed upon affixation of the carrier tape to the foam material. Such a release liner does not necessarily have to be provided.

As the release liner, customary release papers, for example, may be used without limitation. Examples of release liners usable herein include bases each having a releasably-treated layer; low-adhesive bases composed of fluorochemical polymers; and low-adhesive bases composed of nonpolar polymers. Examples of the base materials each having a releasably-treated layer include plastic films and papers each undergone surface treatment with a release agent such as a silicone release agent, a long-chain alkyl release agent, a fluorine-containing release agent, or molybdenum sulfide release agent. Exemplary fluorochemical polymers in the low-adhesive bases composed of fluorochemical polymers include polytetrafluoroethylenes, polychlorotrifluoroethylenes, poly(vinyl fluoride)s, poly(vinylidene fluoride)s, tetrafluoroethylene-hexafluoropropylene copolymers, and chlorofluoroethylene-vinylidene fluoride copolymers. Exemplary nonpolar polymers in the low-adhesive bases composed of nonpolar polymers include olefinic resins such as polyethylenes and polypropylenes. The release liner may be formed according to a known or customary procedure. The thickness and other conditions of the release liner are not particularly limited.

### (Other Layer)

The carrier tape for a foam material according to the present invention may further have one or more other layers (e.g., an intermediate layer and an under coat) within a range not adversely affecting the advantageous effects of the present invention. For example, another layer may be arranged between the substrate and the pressure-sensitive adhesive layer.

### (Carrier Tape for Foam Material)

The carrier tape for a foam material according to the present invention is a single-coated pressure-sensitive adhesive tape having a pressure-sensitive adhesive layer on one side of a substrate. The carrier tape for a foam material according to the present invention, as having the pressure-sensitive adhesive layer, exhibits a sufficient bond strength to the foam material to hold the foam material, and, after the completion of the intended use, the carrier tape can be easily peeled off and removed from the foam material without causing fracture of the foam material. In addition, upon picking up of the specific foam material, the carrier tape exhibits a sufficient bond strength to the surface provided by the foam layer of the specific foam material, and thus interfacial peeling occurs not at the interface between the carrier tape and the foam material but only at the interface between the pressure-sensitive adhesive layer and the release liner both in the specific foam material.

The carrier tape for a foam material according to the present invention may be prepared using a known or customary process. Typically, the carrier tape may be prepared by applying the pressure-sensitive adhesive composition to one side of the substrate to form a pressure-sensitive adhesive layer thereon, or by transferring a separately-prepared pressure-sensitive adhesive layer to one side of the substrate.

The carrier tape for a foam material according to the present invention is advantageously used as a carrier tape for a foam material, which is used typically in transportation of the foam material, a variety of processing, such as punching and lamination (slicing), on the foam material, assembly of the foam material to a cabinet, and picking up of the foam material.

The foam material is not limited, as long as being a member (material) including a foam. Exemplary foam materials include foam materials each composed of a foam alone, as well as foam materials each including at least a foam, such as multilayer members each having at least one layer composed of a foam; members each including a foam and, provided on a surface thereof, a pressure-sensitive adhesive layer; members each including a foam and, provided on a surface thereof, a layer for improving the affinity for the carrier tape (carrier-tape-corresponding layer); and composite members each including a foam and a double-coated pressure-sensitive adhesive tape. As used herein the term “foam” refers to a structure (foam) including a foam structure (expanded structure).

Exemplary materials for constituting the foam include, but are not limited to, polyolefin resins such as low-density polyethylenes, medium-density polyethylenes, high-density polyethylenes, linear low-density polyethylenes, polypropylenes, copolymers of ethylene and propylene, copolymers of ethylene or propylene with another α-olefin (e.g., butene-1, pentene-1, or hexene-1,4-methylpentene-1), and copolymers of ethylene with another ethylenically unsaturated monomer (e.g., vinyl acrylate, acrylic acid, an acrylic acid ester, methacrylic acid, a methacrylic acid ester, or vinyl alcohol); styrenic resins such as polystyrenes and acrylonitrile-butadiene-styrene copolymers (ABS resins); polyamide resins such as 6-nylon, 66-nylon, and 12-nylon; polyamideimides; polyurethanes; polyimides; polyetherimides; acrylic resins such as poly(methyl methacrylate)s; polyvinyl chloride)s; poly(vinyl fluoride)s; alkenyl aromatic resins; polyester resins such as poly(ethylene terephthalate)s and poly(butylene terephthalate)s; polycarbonates such as bisphenol-A polycarbonates; polyacetals; and poly(phenylene sulfide)s. Each of the resins may be used alone or in combination as the material constituting the foam. The material, if being a copolymer, may be a copolymer in the form of either random copolymer or block copolymer.

Typically, foam materials including polyolefin resin foams have been recently widely used for the reasons typically of satisfactory recyclability, inexpensiveness, and easy availability. Particularly to a foam material of this type, the carrier tape for a foam material according to the present invention exhibits a sufficient bond strength and exhibits good removability because of having the specific pressure-sensitive adhesive layer.

The foam material for which the carrier tape for a foam material according to the present invention is used is not limited and may be a flexible foam material or a rigid foam material. Above all, the carrier tape for a foam material according to the present invention, as having the specific pressure-sensitive adhesive layer, is effectively used for a flexible foam material.

The flexible foam material is a member (material) including a flexible foam. Such a flexible foam is a foam including a fine cell structure and having a high expansion ratio and is generally a foam having a low surface strength (weak pick). The flexible foam has an apparent density of from 0.01 to 0.50 g/cm³, and preferably from 0.03 to 0.10 g/cm³. The flexible foam has a 50% compression load of from 0.1 to 5.0 N/cm², and preferably from 0.3 to 3.0 N/cm². As used herein the term “50% compression load” refers to a compression load upon compression by 50% of the initial thickness.

### (Method for Transporting Foam Material Using Carrier Tape for Foam Material)

A method for transporting a foam material using the carrier tape for a foam material according to the present invention includes the steps of affixing and holding a foam material onto the carrier tape for a foam material, and transporting the foam material to a process of every kind (e.g., processing process or assembling process) according to necessity. In this method, the carrier tape for a foam material plays the function of transporting the foam material.

The carrier tape for a foam material exhibits sufficient bonding reliability to the foam material, because of having a 180-degree peel strength of 0.15 N/20 mm or more at a tensile speed of 300 mm/min with respect to the foam (SCF100). For this reason, the method for transporting a foam material using the carrier tape for a foam material according to the present invention enables secure holding of the foam material and does not suffer from dropping off of the foam material during transportation (transportation trouble) even when the foam material is a flexible foam material.

### (Method for Processing Foam Material Using Carrier Tape for Foam Material)

A method for processing a foam material using the carrier tape for a foam material according to the present invention includes the steps of affixing and holding the foam material onto the carrier tape for a foam material, and, while maintaining this state, performing a processing of every kind (e.g., punching or lamination (slicing)) according to necessity on the foam material. In this method, the carrier tape for a foam material plays a role as a mount for processing.

The carrier tape for a foam material, as having a 180-degree peel strength of 0.15 N/20 mm or more at a tensile speed of 300 ram/min with respect to the foam (SCF100), exhibits sufficient bonding reliability to the foam material. For this reason, the method for processing a foam material using the carrier tape for a foam material according to the present invention enables secure holding of the foam material and does not cause displacement and dropping off of the foam material during processing, even when the foam material is a flexible foam material. Specifically, the method for processing a foam material using the carrier tape for a foam material according to the present invention effectively prevents imperfect processing on the foam material.

### (Method for Assembling Foam Material Using Carrier Tape for Foam Material)

A method for assembling a foam material using the carrier tape for a foam material according to the present invention includes the steps of affixing and holding a foam material onto the carrier tape for a foam material, fixing the foam material as being held by the carrier tape for a foam material to a target (e.g., a product, cabinet, or container) through a pressure-sensitive adhesive layer (a pressure-sensitive adhesive layer provided by another article than the carrier tape for a foam material), thereafter removing the carrier tape for a foam material from the foam material, and thereby assembling the foam material to the target.

Typical examples of the method include a method for assembling a specific foam material using the carrier tape for a foam material. For example, the specific foam material may be one prepared by affixing a foam material to a double-coated pressure-sensitive adhesive tape one side of whose pressure-sensitive adhesive layer being protected by a release liner so that the pressure-sensitive adhesive be in contact with the foam material, in which the double-coated pressure-sensitive adhesive tape has a structure of [(release liner)/(pressure-sensitive adhesive layer)]. In this case, the foam material (specific foam material) may be assembled with a target by affixing the carrier tape for a foam material to the foam material side of the specific foam material (having a structure of [(release liner)/(pressure-sensitive adhesive layer)/(foam material)]), thereby picking up the foam material to give a multilayer structure having a structure of [(carrier tape for a foam material)/(specific foam material)/(pressure-sensitive adhesive layer)], and affixing the pressure-sensitive adhesive layer side of the multilayer structure to the target.

The carrier tape for a foam material, as having a 180-degree peel strength of 0.15 N/20 mm or more at a tensile speed of 300 ram/min with respect to the foam (SCF100), exhibits sufficient bonding reliability to the foam material. For this reason, the method for assembling a foam material using the carrier tape for a foam material according to the present invention does not cause failure in holding of the foam material upon assembly of the foam material and upon picking up of the foam material and thereby does not cause imperfect assembly and imperfect picking up. The method, upon picking up of a specific foam material, excels in peel properties at the interface between the pressure-sensitive adhesive layer and the release liner both in the specific foam material.

In addition, the carrier tape for a foam material has a 180-degree peel strength of 0.30 N/20 mm or less at a tensile speed of 10 m/min with respect to the foam (SCF100). Accordingly, the method for assembling a foam material using the carrier tape for a foam material according to the present invention excels in peel properties to peel off at the interface between the carrier tape and the foam material. Upon removal of the carrier tape from the foam material after the completion of the assembly of the foam material, the method does not cause, for example, foam fracture and deposit (residue) of the pressure-sensitive adhesive layer of the carrier tape.

### EXAMPLES

The present invention will be illustrated in further detail with reference to several working examples below. It should be noted, however, that these examples are never construed to limit the scope of the present invention.

### Examples 1 to 3, Comparative Examples 1 to 3

A series of polymer emulsions was obtained by charging butyl acrylate, butyl methacrylate, acrylic acid, an emulsifier (trade name “AQUARON BC-2020” supplied by Dai-ichi Kogyo Seiyaku Co., Ltd.), and ion-exchanged water in the compositions given in after-mentioned Table 1 into a reactor equipped with a condenser, a nitrogen inlet tube, a thermometer, and a stirrer; further charging 0.1 part by weight of 2,2-azobis(2-amidinopropane)dihydrochloride as a polymerization initiator; and adjusting the resulting mixture with a 10 percent by weight ammonia water so as to have a pH of 8.

Each of the polymer emulsions was mixed with a phosphate surfactant (trade name “Phosphanol RE-410” supplied by Toho Chemical Industry Co., Ltd.) and a water-soluble oxazoline crosslinking agent (trade name “EPOCROS WS-500” supplied by Nippon Shokubai. Co., Ltd., oxazoline group equivalents: 220 g·solid/eq.) in proportions given in after-mentioned Table 1 per 100 parts by weight of the solids content (water-dispersive copolymer) of the polymer emulsion and thereby yielded a series of pressure-sensitive adhesive compositions. The pressure-sensitive adhesive compositions were each applied to one side of a substrate (polyester film, trade name “Lumirror #75 S-27”, supplied by Toray Industries Inc., thickness: 75 μm) so as to have a dry thickness of 10 μm, dried at 80° C. for 5 minutes, and thereby yielded a series of pressure-sensitive adhesive tapes.

The numbers of equivalents of oxazoline groups of the water-soluble oxazoline crosslinking agent per 1 equivalent of carboxyl groups contained in the water-dispersive copolymers were 0.25 in Example 1, 0.33 in Example 2, 0.38 in Example 3, 0.17 in Comparative Example 1, 0.41 in Comparative Example 2, and 0.50 in Comparative Example 3.

TABLE 1

| | | | Examples | | | Comparative Examples | | |
|---|---|---|---|---|---|---|---|---|
| | | | 1 | 2 | 3 | 1 | 2 | 3 |
| Composition | Butyl acrylate | BA | 58 | 58 | 58 | 58 | 58 | 58 |
| [part by | | Toagosei Co. Ltd. | | | | | | |
| weight] | Butyl methacrylate | ACRYESTER B | 40 | 40 | 40 | 40 | 40 | 40 |
| | | Mitsubishi Rayon Co., Ltd. | | | | | | |
| | Acrylic acid | 80% Acrylic acid | 2.0 | 2.0 | 2.0 | 2.0 | 2.0 | 2.0 |
| | | Toagosei Co. Ltd. | | | | | | |
| | Emulsifier | AQUARON BC-2020 | 2.0 | 2.0 | 2.0 | 2.0 | 2.0 | 2.0 |
| | | Dai-ichi Kogyo Seiyaku Co., Ltd. | | | | | | |
| | Phosphate surfactant | Phosphanol RE-410 | 0.6 | 0.6 | 0.6 | 0.6 | 0.6 | 0.6 |
| | | Toho Chemical Industry Co., Ltd. | | | | | | |
| | Ion-exchanged water | — | 105 | 105 | 105 | 105 | 105 | 105 |
| | Water-soluble oxazoline | EPOCROS WS-500 | 1.5 | 2.0 | 2.3 | 1.0 | 2.5 | 3.0 |
| | crosslinking agent | Nippon Shokubai Co., Ltd. | | | | | | |

### Comparative Example 4

An acrylic polymer was obtained by charging 100 parts by weight of 2-ethylhexyl acrylate and 5 parts by weight of 2-hydroxyethyl acrylate as monomers, 100 parts by weight of ethyl acrylate as a solvent, and 0.2 part by weight of azobisisobutyronitrile as a polymerization initiator into a reactor equipped with a thermometer, a stirrer, a nitrogen inlet tube, and a reflux condenser, and carrying out polymerization for 8 hours while controlling the temperature to 60° C. The acrylic polymer had a weight-average molecular weight of 105×10⁴.

To 100 parts by weight (solids content) of the acrylic polymer were added 0.5 part by weight (solids content) of an isocyanate crosslinking agent (trade name “CORONATE L” supplied by Nippon Polyurethane Industry Co., Ltd.), 0.032 part by weight of dioctyltin dilaurate (trade name “OL-1” supplied by Tokyo Fine Chemical Co., Ltd.), and 30 parts by weight of a liquid paraffin (trade name “HICALL K-280” supplied by Kaneda Corporation, number-average molecular weight: 380) and thereby yielded a pressure-sensitive adhesive composition. Next, the pressure-sensitive adhesive composition was applied to a polyester base material (trade name “Lumirror S-10#75” supplied by Toray Industries Inc., thickness: 75 μm) so as to have a dry thickness of 20 μm, dried, and thereby yielded a pressure-sensitive adhesive tape. The pressure-sensitive adhesive layer at this time point had a solvent-insoluble content of 63 percent by weight.

### (Evaluation)

With respect to a foam (trade name “SCF100” supplied by Nitto Denko Corporation), 180-degree peel strengths (under a high-speed peel condition and a low-speed peel condition), peel pattern under the high-speed peel condition, and picking-up properties were evaluated. Measurement results and evaluation results are shown in Table 2 below.

### (180-Degree Peel Strength)

Each of the prepared pressure-sensitive adhesive tapes was cut to a size of 20 mm wide and 100 mm long and thereby yielded a series of measurement samples.

The adhesive face of each measurement sample was adhered to a foam (trade name “SCF100” supplied by Nitto Denko Corporation) through compression bonding with one reciprocating movement of a 2-kg roller and left stand in an environment at 23° C. and 50% relative humidity for 30 minutes.

After leaving left stand, peeling at a peel angle of 180° was performed under a low-speed peel condition [tensile speed: 300 mm/min, using a universal tensile and compression testing machine (device name “Tensile and Compression Testing Machine TG-1kN”, supplied by Minebea Co., Ltd.)] and under a high-speed peel condition [tensile speed: 10 m/min, using a high-speed peel testing machine (supplied by Tester Sangyo Co., Ltd.)], and 180-degree peel strengths were measured. The measurement was performed in an environment at 23° C. and 50% relative humidity.

Measurement results are shown in Table 2 below.

### (Peel Pattern Under High-Speed Peel Condition)

In measurement of the 180-degree peel strength under the high-speed peel condition, (1) a sample where peeling occurred at the interface between the pressure-sensitive adhesive tape and the foam (SCF100) without causing failure of the foam (SCF100) was evaluated as “interfacial” (peeling); (2) a sample where fragments (broken pieces) of the foam (SCF100) was attached to the pressure-sensitive adhesive tape, and failure of the foam (SCF100) wholly occurred was evaluated as “foam fracture”; and (3) fragments (broken pieces) of the foam (SCF100) was partially attached to the pressure-sensitive adhesive tape, and failure of the foam (SCF100) partially occurred was evaluated as “partial foam fracture.”

### (Picking-Up Properties)

A double-coated pressure-sensitive adhesive tape (trade name “No. 5605”, supplied by Nitto Denko Corporation, having a multilayer structure of [(pressure-sensitive adhesive layer)/(separator)]) was affixed to a foam (trade name “SCF100”, supplied by Nitto Denko Corporation) through compression bonding with one reciprocating movement of a 2-kg roller, was left stand in an environment at 23° C. and 50% relative humidity for 30 minutes, and thereby yielded a multilayer article having a structure of [(foam (SCF100))/(double-coated pressure-sensitive adhesive tape (No. 5605 Tape))]. A separator used in the double-coated pressure-sensitive adhesive tape (No. 5605 Tape) is a polyester film (thickness 75 μm), one side of which has been treated with a silicone release agent.

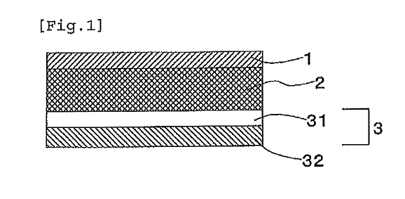

Next, the adhesive face of each of the prepared pressure-sensitive adhesive tapes (pressure-sensitive adhesive tapes according to examples and comparative examples) was affixed to a side provided by the foam (SCF100) of the multilayer article through compression bonding with one reciprocating movement of a 2-kg roller, left stand in an environment at 23° C. and 50% relative humidity for 30 minutes, and thereby yielded a series of evaluation samples (FIG. 1) having a structure of [(pressure-sensitive adhesive tape (pressure-sensitive adhesive tape according to the examples or comparative examples))/(foam (SCF100))/(double-coated pressure-sensitive adhesive tape (No. 5605 Tape))].

The picking-up properties of the evaluation samples were evaluated according to the following criteria by peeling off the separator of the double-coated pressure-sensitive adhesive tape (No. 5605 Tape) of the evaluation sample by hand.

### Criteria

Good: The separator could be removed without peeling off of the foam (SCF100) from the pressure-sensitive adhesive tape (pressure-sensitive adhesive tape according to any of the examples or comparative examples).

Poor: Upon peeling off of the separator, a phenomenon occurred in which the foam (SCF100) was peeled off from the pressure-sensitive adhesive tape (pressure-sensitive adhesive tape according to any of the examples and comparative examples).

FIG. 1 depicts a schematic cross-sectional view of an evaluation sample for use in evaluation of picking-up properties. In FIG. 1, the reference sign “1” stands for the pressure-sensitive adhesive tape (pressure-sensitive adhesive tape according to any of the examples and comparative examples), “2” stands for the foam (trade name “SCF100”, supplied by Nitto Denko Corporation), “3” stands for the double-coated pressure-sensitive adhesive tape (trade name “No. 5605”, supplied by Nitto Denko Corporation), “31” stands for the pressure-sensitive adhesive layer in the double-coated pressure-sensitive adhesive tape (trade name “No. 5605”, supplied by Nitto Denko Corporation), and “32” stands for the separator in the double-coated pressure-sensitive adhesive tape (trade name “No. 5605”, supplied by Nitto Denko Corporation).

TABLE 2

| | 180-Degree peel strength | | | |
|---|---|---|---|---|
| | [N/20 mm] | | | |
| | Low-speed | High-speed | | Peel pattern |
| | peel | peel | Picking-up | under high-speed |
| | condition | condition | properties | peel condition |
| Example 1 | 0.33 | 0.20 | Good | Interfacial |
| Example 2 | 0.21 | 0.15 | Good | Interfacial |
| Example 3 | 0.19 | 0.13 | Good | Interfacial |
| Comparative | 0.45 | 0.32 | Good | Partial foam |
| Example 1 | | | | fracture |
| Comparative | 0.11 | 0.08 | Poor | Interfacial |
| Example 2 | | | | |
| Comparative | 0.08 | 0.05 | Poor | Interfacial |
| Example 3 | | | | |
| Comparative | 0.01 | 0.40 | Poor | Foam fracture |
| Example 4 | | | | |

### INDUSTRIAL APPLICABILITY

The carrier tape for a foam material according to the present invention is used typically in transportation of the foam material, punching or another processing on the foam material, assembly of the foam material to a cabinet, and picking up of the foam material.

### REFERENCE SIGNS LIST

1 pressure-sensitive adhesive tape (pressure-sensitive adhesive tape according to example or comparative example)
2 foam (trade name “SCF100”, supplied by Nitto Denko Corporation)
3 double-coated pressure-sensitive adhesive tape (trade name “No. 5605”, supplied by Nitto Denko Corporation)
31 pressure-sensitive adhesive layer
32 separator

1. A carrier tape for a foam material, comprising a substrate; and a pressure-sensitive adhesive layer present on or above one side of the substrate, wherein the carrier tape has a 180-degree peel strength of 0.15 newton per 20 millimeters (N/20 mm) or more at a tensile speed of 300 millimeters per minute (mm/min) with respect to a foam (trade name “SCF100”, supplied by Nitto Denko Corporation), and wherein the carrier tape has a 180-degree peel strength of 0.30 N/20 mm or less at a tensile speed of 10 meters per minute (m/min) with respect to the foam (trade name “SCF100”, supplied by Nitto Denko Corporation).

2. The carrier tape for a foam material according to claim 1, wherein the pressure-sensitive adhesive layer is an acrylic pressure-sensitive adhesive layer.

3. The carrier tape for a foam material according to claim 1, wherein the pressure-sensitive adhesive layer contains a crosslinking agent.

4. The carrier tape for a foam material according to claim 2, wherein the acrylic pressure-sensitive adhesive layer principally comprises an acrylic polymer including, as a principal structural component, an alkyl (meth)acrylate whose alkyl moiety having 1 to 14 carbon atoms.

5. The carrier tape for a foam material according to claim 4, wherein the acrylic copolymer is a water-dispersive acrylic copolymer.

6. The carrier tape for a foam material according to claim 1, wherein the pressure-sensitive adhesive layer has a thickness of from 2 to 40 μm.

7. The carrier tape for a foam material according to claim 1, wherein the substrate has a thickness of from 1 to 1000 μm.

8. A method for transporting a foam material, the method using the carrier tape for a foam material of claim 1.

9. A method for processing a foam material, the method using the carrier tape for a foam material of claim 1.

10. A method for assembling a foam material, the method using the carrier tape for a foam material of claim 1.

11. The carrier tape for a foam material according to claim 2, wherein the pressure-sensitive adhesive layer contains a crosslinking agent.

12. The carrier tape for a foam material according to claim 2, wherein the pressure-sensitive adhesive layer has a thickness of from 2 to 40 μm.

13. The carrier tape for a foam material according to claim 3, wherein the pressure-sensitive adhesive layer has a thickness of from 2 to 40 μm.

14. The carrier tape for a foam material according to claim 4, wherein the pressure-sensitive adhesive layer has a thickness of from 2 to 40 μm.

15. The carrier tape for a foam material according to claim 5, wherein the pressure-sensitive adhesive layer has a thickness of from 2 to 40 μm.

16. The carrier tape for a foam material according to claim 2, wherein the substrate has a thickness of from 1 to 1000 μm.

17. The carrier tape for a foam material according to claim 3, wherein the substrate has a thickness of from 1 to 1000 μm.

18. The carrier tape for a foam material according to claim 4, wherein the substrate has a thickness of from 1 to 1000 μm.

19. The carrier tape for a foam material according to claim 5, wherein the substrate has a thickness of from 1 to 1000 μm.

20. The carrier tape for a foam material according to claim 6, wherein the substrate has a thickness of from 1 to 1000 μm.
